(19) United States
(12) Patent Application Publication
(10) Pub. No.: US 2024/0406834 A1
(43) Pub. Date: Dec. 5, 2024

(54) METHOD AND APPARATUS FOR ESTABLISHING AND MODIFYING TRAFFIC PATH ON BASIS OF SERVICE DATA FLOW IN MOBILE COMMUNICATION SYSTEM

(71) Applicant: Electronics and Telecommunications Research Institute, Daejeon (KR)

(72) Inventors: Sunjin KIM, Daejeon (KR); Namseok KO, Daejeon (KR); Jong Seok LEE, Daejeon (KR); Sun Me KIM, Daejeon (KR)

(21) Appl. No.: 18/660,139

(22) Filed: May 9, 2024

(30) Foreign Application Priority Data
May 30, 2023 (KR) 10-2023-0069415
Sep. 14, 2023 (KR) 10-2023-0122362

(51) Int. Cl. H04W 40/02; H04L 45/036; H04L 45/302; H04L 47/20

(52) U.S. Cl. CPC H04W 40/02; H04L 45/036; H04L 45/308; H04L 47/20

(57) ABSTRACT

A method and apparatus for establishing and modifying a traffic path on basis of a service data flow in a mobile communication system is proposed. The method includes steps of receiving an SM policy association establishment request message or an SM policy association modification request message on the basis of PDU session establishment, obtaining policy-related information from a UDR on the basis of an SM policy association establishment request or an SM policy association modification request, and performing a policy decision on the basis of whether a previously stored PCC rule related to the PDU session establishment exists in the policy-related information, wherein the policy decision may include traffic routing for each service data flow (SDF) and include a step of transmitting an SM policy association establishment response message or an SM policy association modification response message, which includes policy decision information, to a SMF.

### CROSS REFERENCE TO RELATED APPLICATION

The present application claims priority to Korean Patent Application Nos. 10-2023-0069415, filed May 30, 2023 and 10-2023-0122362, filed Sep. 14, 2023, the entire contents of which are incorporated herein for all purposes by this reference.

### BACKGROUND OF THE INVENTION

### Field of the Invention

The present disclosure relates to a method and apparatus for establishing and modifying a traffic path on the basis of a service data flow (SDF) in a mobile communication system. More particularly, the present disclosure relates to a method and apparatus for establishing a traffic path (t-path) through a routing identification (RID) returned for each SDF.

### Description of the Related Art

With the development of 5G mobile technology, various network-based application services are spreading. These application services are developing into a distributed service structure based on network function virtualization (NFV). However, since a current mobile network architecture was designed without considering a transport layer, it may not quickly respond to requirements of bandwidths and low latency of various application services.

In addition, a user plane layer of a mobile communication system is divided into a (radio) access network ((R)AN), a core network which are connected to each other by tunneling based on GTP-U, i.e., General packet radio system (GPRS) Tunneling Protocol-User plane, and a service network. Accordingly, there are limitations in optimizing and operating network paths according to the requirements of individual application services.

### SUMMARY OF THE INVENTION

The present disclosure relates to a method and apparatus for generating a policy and charging control (PCC) rule including a traffic path (t-path) in a mobile communication system.

The present disclosure relates to a method and apparatus for establishing a traffic path included in a PCC rule on the basis of a routing ID (RID) returned for each service data flow (SDF) in a mobile communication system.

The present disclosure relates to a method and apparatus for indicating a traffic path (t-path) by using an RID including only a locator in a mobile communication system.

The technical objectives to be achieved by the present disclosure are not limited to the matters described above, and other technical problems not described above may be considered by those skilled in the art to which the technical configuration of the present disclosure is applied from exemplary embodiments of the present disclosure that will be described below.

According to an exemplary embodiment, there is provided an apparatus for establishing a traffic path and transmitting the established traffic path in a mobile communication system, the apparatus including: a memory for storing at least one program; a transmitting and receiving unit for transmitting and receiving at least one signal; and a processor for executing at least one program stored in the memory, wherein the processor may receive a session management (SM) policy association establishment request message or an SM policy association modification request message on the basis of protocol data unit (PDU) session establishment, obtain policy-related information from a unified data repository (UDR) on the basis of an SM policy association establishment request or an SM policy association modification request, and perform a policy decision on the basis of whether a previously stored policy and charging control (PCC) rule related to the PDU session establishment exists in the policy-related information, and the policy decision may include traffic routing for each service data flow (SDF), and transmit an SM policy association establishment response message or an SM policy association modification response message, which includes policy decision information, to a session management function (SMF).

In addition, according to the exemplary embodiment, there is provided a method of operating an apparatus for establishing a traffic path and transmitting the established traffic path in a mobile communication system, the method including: receiving an SM policy association establishment request message or an SM policy association modification request message on the basis of protocol data unit (PDU) session establishment; obtaining policy-related information from a UDR on the basis of an SM policy association establishment request or an SM policy association modification request; and performing a policy decision on the basis of whether a previously stored PCC rule related to the PDU session establishment exists in the policy-related information, wherein the policy decision may include traffic routing for each service data flow (SDF) and include a step of transmitting an SM policy association establishment response message or an SM policy association modification response message, which includes policy decision information, to a session management function (SMF).

The present disclosure may provide a method for generating a PCC rule including a traffic path in a mobile communication system.

The present disclosure may provide a method of establishing a traffic path included in a PCC rule based on an RID returned for each SDF in a mobile communication system.

The present disclosure may provide a method of indicating a traffic path (t-path) by using an RID including only a locator in a mobile communication system.

The effects that may be obtained from exemplary embodiments of the present disclosure are not limited to the effects described above, and from the description of the exemplary embodiments of the present disclosure below, other effects not described may clearly derived and understood by those skilled in the art to which the technical configuration of the present disclosure is applied. That is, unintended effects resulting from implementing the configuration described in the present disclosure may also be derived by those skilled in the art from the exemplary embodiments of the present disclosure.

### BRIEF DESCRIPTION OF THE DRAWINGS

FIG. 1 is a conceptual view illustrating a mobile communication system applicable to the present disclosure.

FIG. 2 is a view illustrating an apparatus configuration applicable to the present disclosure.

FIG. 3 is a view illustrating reference points applicable to the present disclosure.

FIG. 4 is a view illustrating a method of performing SM policy association establishment applicable to the present disclosure.

FIG. 5 is a view illustrating a method of performing SM policy association modification initiated by an SMF and applicable to the present disclosure.

FIG. 6 is a view illustrating a method of performing the SM policy association modification initiated by a PCF and applicable to the present disclosure.

FIG. 7 is a view illustrating a method of performing SM policy association establishment applicable to the present disclosure.

FIG. 8 is a view illustrating a method of performing SM policy association establishment applicable to the present disclosure.

FIG. 9 is a view illustrating a method of performing traffic routing applicable to the present disclosure.

FIG. 10 is a view illustrating a method for establishing a path in a PDU session procedure applicable to the present disclosure.

FIG. 11 is a view illustrating a SID structure applicable to the present disclosure.

FIG. 12 is a flowchart for PCF operation to which the present disclosure is applicable.

FIG. 13 is a flowchart for PCF operation to which the present disclosure is applicable.

### DETAILED DESCRIPTION OF THE INVENTION

In the present disclosure, various modifications may be made and various exemplary embodiments may be provided, and specific exemplary embodiments will be illustrated in the drawings and described in detail. However, this is not intended to limit the present disclosure to a particular disclosed form. On the contrary, the present disclosure is to be understood to include all various alternatives, equivalents, and substitutes that may be included within the idea and technical scope of the present disclosure.

It will be understood that, although the terms first, second, etc. may be used herein to describe various components, these components should not be limited by these terms. These terms are only used for the purpose of distinguishing one component from another component. For example, a first component may be referred to as a second component without departing from the scope of the present disclosure, and similarly, the second component may be referred to as the first component. The term “and/or” includes any of the plurality of related and described items or a combination of the plurality of related and described items.

In the exemplary embodiments of the present application, “at least one of A and B” may mean “at least one of A or B” or “at least one of combinations of one or more of A and B”. In addition, in the exemplary embodiments of the present application, “one or more of A and B” may mean “one or more of A or B” or “one or more of combinations of one or more of A and B.”

In addition, in the exemplary embodiments of the present application, “at least one of A, B, and C” may mean “only A”, “only B”, and “only C”, or may mean “any combination of A, B, and C”. In addition, “at least one of A, B, or C” or “at least one of A, B, and/or C” may mean “at least one of A, B, and C”.

In the exemplary embodiments of the present application, retransmission may mean “transmission”, “retransmission”, or “transmission and retransmission”, resetting may mean “setting”, “resetting”, or “setting and resetting”, reconnection may mean “connection”, “reconnection”, or “connection and reconnection”, and re-access may mean “access”, “re-access”, or “access and re-access”.

When a component is described as being “connected”, “coupled”, or “linked” to another component, that component may be directly connected, coupled, or linked to that other component. However, it should be understood that a yet another component between each of the components may be present. In contrast, when a component is described as being “directly connected”, “directly coupled”, or “directly linked” to another component, it should be understood that there are no intervening component present therebetween.

The terminology used herein is for the purpose of describing particular exemplary embodiments only and is not intended to be limiting. As used herein, the singular forms are intended to include the plural forms as well, unless the context clearly indicates otherwise. In addition, it will be further understood that the terms “comprise”, “include”, “have”, and the like when used in the present application specify the presence of stated features, integers, steps, operations, components, parts, and/or combinations thereof, but do not preclude the possibility of the presence or addition of one or more other features, integers, steps, operations, components, parts, and/or combinations thereof.

Unless otherwise defined, all terms including technical and scientific terms used herein have the same meaning as commonly understood by those skilled in the art to which the present disclosure belongs. It will be further understood that terms as defined in dictionaries commonly used herein should be interpreted as having a meaning that is consistent with their meaning in the context of the related art, and will not be interpreted in an idealized or overly formal sense unless expressly so defined herein.

Hereinafter, preferred exemplary embodiments of the present disclosure will be described in more detail with reference to the accompanying drawings. In order to facilitate overall understanding when the present disclosure is described, the same reference numerals are used for the same components in the drawings, and duplicate descriptions for the same components are omitted.

A communication network to which the exemplary embodiments according to the present disclosure are applied will be described. The communication network may include a non-terrestrial network (NTN), a 4G communication network (e.g., a long-term evolution (LTE) communication network), a 5G communication network (e.g., a new radio (NR) communication network), etc. In addition, as an example, the next-generation communication network may be a 6G communication network or a new type of communication network, and is not limited to a specific type thereof. Throughout the present specification, a network refers to, for example, a wireless Internet such as wireless fidelity (WiFi), a mobile internet such as wireless broadband (WiBro) internet or world interoperability for microwave access (WiMax), a 2G mobile communication network such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as long term evolution (LTE) network or LTE-Advanced network, a 5G mobile communication network of NR, the 6G communication network as another next-generation communication network, other networks, etc., and may not be limited to specific types thereof.

Throughout the present specification, a terminal may refer to a User Equipment (UE), an access terminal, a mobile terminal, a station, a subscriber station, a mobile station, a portable subscriber station, a node, a device, etc.

Here, a device, which is capable of communicating with the above terminal, may be used, including: a desktop computer, a laptop computer, a tablet PC, a wireless phone, a mobile phone, and a smartphone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, etc.

Throughout the present specification, a base station may be referred to as a Node B, a base transceiver station (BTS), a radio base station, a radio transceiver, an access point, an access node, a roadside side unit (RSU), a digital unit (DU), a cloud digital unit (CDU), a radio remote head (RRH), a radio unit (RU), a transmission point (TP), a transmission and reception point (TRP), a relay node, etc.

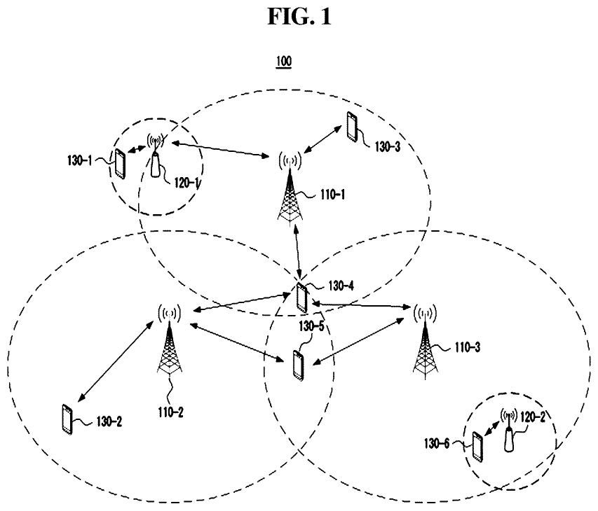

FIG. 1 is a conceptual view illustrating a mobile communication system according to an exemplary embodiment.

Referring to FIG. 1, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communication (e.g., long term evolution (LTE), LTE-A (LTE-Advanced)), 5G communication (e.g., new radio (NR)), next-generation communication (e.g., 6G), etc., which are specified in the 3rd generation partnership project (3GPP) standards. The 4G communication may be performed in frequency bands 6 GHz or below, and the 5G communication may be performed in frequency bands above 6 GHz as well as 6 GHz or below. The 6G communication may use a THz frequency band, and the like, or may be applied with artificial intelligence (AT) and other technologies, but is not limited to a specific form thereof.

For example, for the 4G communication, 5G communication, and 6G communication, the plurality of communication nodes may support communication protocol based on code division multiple access (CDMA), communication protocol based on wideband CDMA (WCDMA), communication protocol based on time division multiple access (TDMA), communication protocol based on frequency division multiple access (FDMA), communication protocol based on orthogonal frequency division multiplexing (OFDM), communication protocol based on Filtered OFDM communication protocol based on cyclic prefix (CP)-OFDM, communication protocol based on discrete Fourier transform-spread-OFDM (DFT-s-OFDM), communication protocol based on orthogonal frequency division multiple access (OFDMA), communication protocol based on single carrier (SC)-FDMA, communication protocol based on non-orthogonal Multiple Access (NOMA), communication protocol based on generalized frequency division multiplexing (GFDM), communication protocol based on filter bank multi-carrier (FBMC), communication protocol based on universal filtered multi-carrier (UFMC), communication protocol based on space division multiple access (SDMA), etc.

In addition, the communication system 100 may further include a core network. In a case where the communication system 100 supports 4G communication, the core network may include a serving-gateway (S-GW), a P-GW (i.e., a packet data network (PDN)-gateway), a mobility management entity (MME), etc. In a case where the communication system 100 supports 5G communication, a core network may include a user plane function (UPF), a session management function (SMF), an access and mobility management function (AMF), etc. In addition, as an example, in a case where the communication system 100 supports the 5G communication, the core network may be configured on the basis of a new function or a function based on the 5G communication, and may not be limited to a specific form thereof.

Meanwhile, the plurality of communication nodes 110-1, 110-2, 110-3, 120-1, 120-2, 130-1, 130-2, 130-3, 130-4, 130-5, and 130-6, or network functions (NFs), which constitute the communication system 100 may each have the following structure.

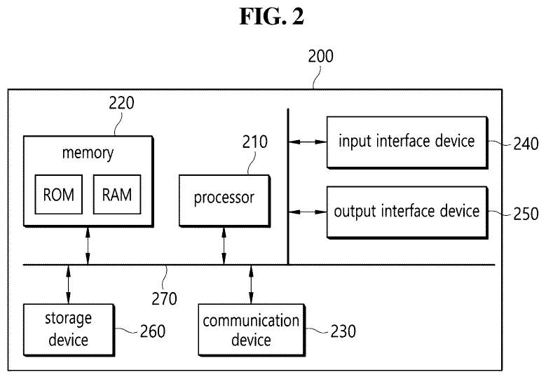

FIG. 2 is a view illustrating an apparatus configuration according to an exemplary embodiment. Referring to FIG. 2, a communication node (NF) 200 may include at least one processor 210, a memory 220, and a communication (or transmission/reception) device 230 connected to a network and performing communication. In addition, the communication node 200 may further include an input interface device 240, an output interface device 250, a storage device 260, etc. Each component included in the communication node 200 is connected by a bus 270 to communicate with each other.

However, each component included in the communication node 200 may also be connected to each other through an individual interface or individual bus centered on the processor 210, rather than through the common bus 270. For example, the processor 210 may also be connected to at least one of the memory 220, the communication device 230, the input interface device 240, the output interface device 250, and the storage device 260 through a dedicated interface.

The processor 210 may execute a program command stored in at least one of the memory 220 and the storage device 260. The processor 210 may refer to a central processing unit (CPU), a graphics processing unit (GPU), or a dedicated processor on which a method according to the exemplary embodiments of the present disclosure is performed. Each of the memory 220 and the storage device 260 may consist of at least one of a volatile storage medium and a non-volatile storage medium. For example, the memory 220 may consist of at least one of read only memory (ROM) and random access memory (RAM).

Referring back to FIG. 1, the communication system 100 may include: a plurality of base stations 110-1, 110-2, 110-3, 120-1, and 120-2; and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an “access network”. Each of a first base station 110-1, a second base station 110-2, and a third base station 110-3 may form a macro cell. Each of a fourth base station 120-1 and a fifth base station 120-2 may form a small cell. The fourth base station 120-1, the third terminal 130-3, and the fourth terminal 130-4 may belong to within a cell coverage of the first base station 110-1. The second terminal 130-2, the fourth terminal 130-4, and the fifth terminal 130-5 may belong to within a cell coverage of the second base station 110-2. The fifth base station 120-2, the fourth terminal 130-4, the fifth terminal 130-5, and the sixth terminal 130-6 may belong to within a cell coverage of the third base station 110-3. The first terminal 130-1 may belong to within a cell coverage of the fourth base station 120-1. The sixth terminal 130-6 may belong to within a cell coverage of the fifth base station 120-2.

Here, each of the plurality of base stations 110-1, 110-2, 110-3, 120-1, and 120-2 may be referred to as a Node B, an evolved Node B, a gNB, an xNB, a base transceiver station (BTS), a radio base station, a radio transceiver, an access point, an access node, etc. Each of the plurality of terminals 130-1, 130-2, 130-3, 130-4, 130-5, and 130-6 may be referred to as user equipment (UE), a terminal, an access terminal, a mobile terminal, a station, a subscriber station, a mobile station, a portable subscriber station, a node, a device, etc.

Meanwhile, each of the plurality of base stations 110-1, 110-2, 110-3, 120-1, and 120-2 may operate in frequency bands different from each other, or may operate in the same frequency band. Each of the plurality of base stations 110-1, 110-2, 110-3, 120-1, and 120-2 may be connected to each other through an ideal backhaul link or a non-ideal backhaul link, and may exchange information with each other through the ideal backhaul link or the non-ideal backhaul link. Each of the plurality of base stations 110-1, 110-2, 110-3, 120-1, and 120-2 may be connected to a core network through the ideal backhaul link or the non-ideal backhaul link. Each of the plurality of base stations 110-1, 110-2, 110-3, 120-1, and 120-2 may transmit signals received from the core network to corresponding terminals 130-1, 130-2, 130-3, 130-4, 130-5, and 130-6, and may transmit signals received from the corresponding terminals 130-1, 130-2, 130-3, 130-4, 130-5, and 130-6 to the core network.

In addition, as an example, the core network of a communication system is configured with an architecture based on interaction between NFs. For example, a 5G Core (5GC) as the core network of the 5G system may include various entities. Specifically, an AMF may manage access and mobility of terminals. The AMF may perform functions of non-access stratum (NAS) security management and mobility management for dormant terminals.

An SMF may manage sessions. As an example, the SMF may perform a function of allocating an Internet protocol (IP) address of a terminal, and control a protocol data unit (PDU) session.

In addition, a policy control function (PCF) may perform a function of controlling policy. In addition, a UPF may perform a function of controlling a user plane. The UPF is a gateway function for transmitting and receiving data, and may perform all or some of user plane functions of a serving gateway (S-GW) and a packet data network gateway (P-GW) of a previous mobile communication system (e.g., 4G). In addition, the UPF may perform a function of handling PDUs. In addition, an application function (AF) may control application functions. The AF may perform a function of providing a plurality of services to a terminal. Unified data management (UDM) may perform a function of managing integrated data. Here, the UDM may perform a function of managing subscriber information.

In addition, as an example, a core network of a next-generation system (e.g., 6G) may be referred to as the same name with the same type of function as that of a 5G system, or may be configured with a new entity (or a function) based on the next-generation system, but is not limited to a specific exemplary embodiment thereof. However, described above, the next-generation system may consist of functions for managing access and mobility of terminals or for managing sessions, and may be equally applied to the matters described below. In the following, for convenience of description, the disclosed is described on the basis of a 5G system, but is not limited thereto and may also be equally applied to the next-generation system.

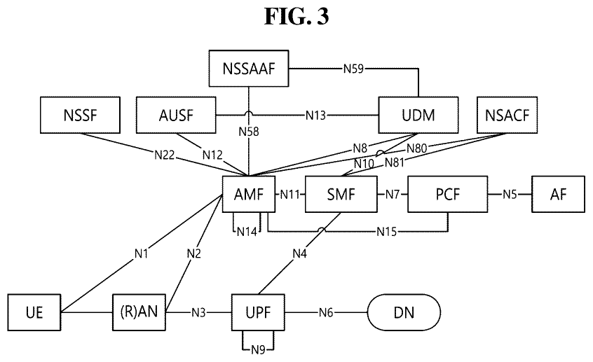

FIG. 3 is a view illustrating reference points according to the exemplary embodiment of the present disclosure. Referring to FIG. 3, the reference points may represent interaction between NF services within NFs and described by a point-to-point reference point between any two network functions (NFs). As an example, Ni may be a reference point between a UE and an AMF. N2 may be a reference point between a (R)AN and the AMF. N3 may be a reference point between the (R)AN and a UPF. Other reference points may be the same as those shown in Table 1 below, but may not be limited thereto.

TABLE 1
N1: Reference point between the UE and the AMF.
N2: Reference point between the (R)AN and the AMF.
N3: Reference point between the (R)AN and the UPF.
N4: Reference point between the SMF and the UPF.
N5: Reference point between the PCF and an AF or TSN AF.
N6: Reference point between the UPF and a Data Network.
N7: Reference point between the SMF and the PCF.
N8: Reference point between the UDM and the AMF.
N9: Reference point between two UPFs.
N10: Reference point between the UDM and the SMF.
N11: Reference point between the AMF and the SMF.
N12: Reference point between AMF and AUSF.
N13: Reference point between the UDM and Authentication Server
function the AUSF.
N14: Reference point between two AMFs.
N15: Reference point between the PCF and the AMF in the case of non-
roaming scenario, PCF in the visited network and AMF in the case of
roaming scenario.
N16: Reference point between two SMFs, (in roaming case between SMF
in the visited network and the SMF in the home network).
N16a: Reference point between SMF and I-SMF.
N17: Reference point between AMF and 5G-EIR.
N18: Reference point between any NF and UDSF.
N19: Reference point between two PSA UPFs for 5G LAN-type service.
N22: Reference point between AMF and NSSF.

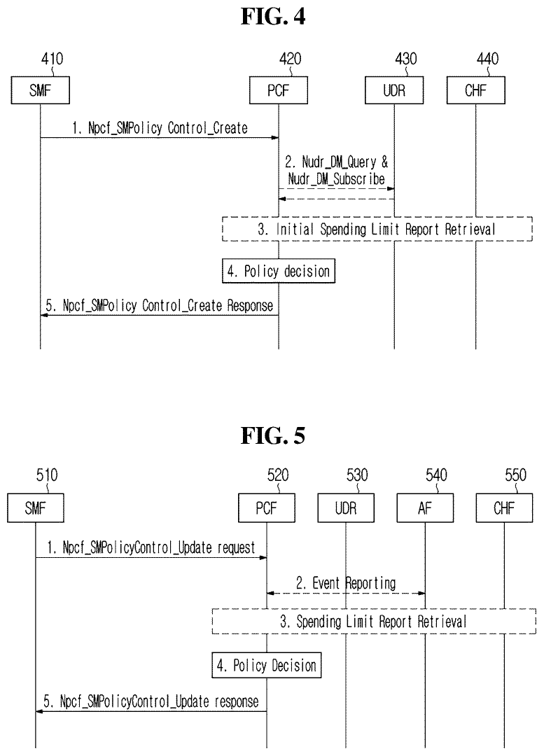

FIG. 4 is a view illustrating a method of performing SM policy association establishment applicable to the present disclosure.

Referring to FIG. 4, an SMF 410 may transmit an SM policy association establishment request message to a PCF 420. The SMF 410 may receive a protocol data unit (PDU) session establishment request message from a UE and select the PCF 420. The SMF 410 may transmit the SM policy association establishment request message to the selected PCF 420. As an example, the above-described request message may include PDU session-related information. As a specific example, the PDU session-related information may further include at least any one of a subscription permanent identifier (SUPI), a PDU session ID, a PDU session type, a data network name (DNN), single-network slice selection assistance information (S-NSSAI), a generic public subscription identifier (GPSI), an internal group identifier, an access type, an IPv4 address, and/or an IPv6 network prefix. In addition, the PDU session-related information may further include additional information other than the information described above, and may not be limited to specific information thereof.

Thereafter, the PCF 420 may inquire about policy-related information from a unified data repository (UDR) 430. As a specific example, in a case of not having the policy-related information, the PCF 420 may invoke “Nudr_DM_Query” to receive the PDU session-related information. The “Nudr_DM_Query” may include SUPI, DNN, S-NSSAI, policy data, PDU session policy control data, and the remaining allowed usage data, but is not limited thereto. In addition, the PCF 420 may invoke “Nudr_DM_Susbcribe” to the UDR 430 in order to transmit a request for notification when the policy-related information is changed. The “Nudr_DM_Susbcribe” may include policy data, SUPI, DNN, S-NSSAI, a notification target address (+notification correlation Id), event reporting information (continuous reporting), PDU session policy control data, and the remaining allowed usage data, but is not limited thereto.

Here, in a case where a policy decision of the PCF 420 depends on policy counter status of a charging function (CHF) 440 and reporting for a corresponding subscriber is not yet set, the PCF 420 may perform initial spending limit report retrieval. In contrast, in a case where the policy counter status is already set for a corresponding subscriber, the PCF 420 may check whether additional policy counter status is required or not and perform the intermediate spending limit report retrieval, but is not limited thereto.

Thereafter, the PCF 420 may perform a policy decision. As an example, the PCF 420 may transmit a rejection message for SM policy association establishment to the SMF 410 when validity conditions are not satisfied on the basis of the policy decision. In contrast, the PCF 420 may transmit an SM association establishment response message to the SMF 410 when the validity conditions are satisfied on the basis of the policy decision, and the SM association establishment response message may include the determined policy information. Thereafter, the PCF 420 may obtain PDU session-related change information from the SMF 410 through an event subscription related to a PDU session.

FIG. 5 is a view illustrating a method of performing SM policy association modification initiated by an SMF and applicable to the present disclosure.

Referring to FIG. 5, the SMF 510 may perform an SM policy association modification procedure when policy control request triggering conditions are satisfied. Referring to FIG. 5, the SMF 510 may transmit an SM policy association update request message to the PCF 520 when the policy control request triggering conditions am satisfied. As an example, in a case where an application function (AF) 540 has subscribed to an SMF reporting-based event, the PCF 520 may invoke a policy authentication notification operation to report the event to the AF, or to a time sensitive communication time synchronization function (TSCTSF). As an example, the policy control request triggering conditions may be as shown in Table below, but may not be limited thereto.

TABLE 2

| | | | | |
|---|---|---|---|---|
| | | Difference | | |
| | | compared with | | |
| | | table 6.2 and | | |
| Policy Control | | table A.4.3-2 in | Conditions | |
| Request Trigger | Description | TS 23.203 [4] | for reporting | Motivation |

| | | | |
|---|---|---|---|
| PLMN change | The UE has moved to another | None | PCF |
| | operators' domain. | | |

.
.
.

| | | | |
|---|---|---|---|
| Resource | A request for resource | None | SMF |
| modification | modification has been received | | always |
| request | by the SMF. | | reports |
| | | | to PCF |

.
.
.

| | | | | |
|---|---|---|---|---|
| Usage report | The PDU Session or the | None | PCF | |
| (NOTE 4) | Monitoring key specific | | | |
| | resources consumed by a UE | | | |
| | either reached the threshold | | | |
| | or needs to be reported for | | | |
| | other reasons. | | | |
| Start of | The start or the stop of | None | PCF | |
| application | application traffic has been | | | |
| traffic detection | detected. | | | |
| and Stop of | | | | |
| application | | | | |
| traffic detection | | | | |
| (NOTE 5) | | | | |
| SRVCC CS to | A CS to PS handover has been | Removed | | No support |
| PS handover | detected. | | | in 5GS yet |
| Access Network | Access information as specified | None | PCF | |
| Information | in the Access Network | | | |
| report | Information Reporting part of a | | | |
| | PCC rule. | | | |
| Credit | Transient/Permanent failure as | None | PCF | |
| management | specified by the CHF. | | | |
| session failure | | | | |
| Addition/ | The PCEF reports when an | Removed | | No support |
| removal of an | access is added or removed. | | | in 5GS yet |
| access to an IP- | | | | |
| CAN session | | | | |
| Change of | The PCEF reports that an access | Removed | | No support |
| usability of an | becomes unusable or usable | | | in 5GS yet |
| access | again. | | | |
| 3GPP PS Data | The SMF reports when the | None | SMF | |
| Off status | 3GPP PS Data Off status | | always | |
| change | changes. | | reports | |
| | | | to PCF | |
| Session AMBR | The Session-AMBR has | Added | SMF | |
| change | changed. | | always | |
| | | | reports | |
| | | | to PCF | |
| Default QoS | The subscribed QoS has | Added | SMF | |
| change | changed. | | always | |
| | | | reports | |
| | | | to PCF | |
| Removal of | The SMF reports when the PCC | Added | SMF | |
| PCC rule | rule is removed. | | always | |
| | | | reports | |
| | | | to PCF | |
| Successful | The SMF reports to the PCF | Added | PCF | |
| resource | that the resources for a PCC rule | | | |
| allocation | have been successfully | | | |
| | allocated. | | | |
| GFBR of the | The SMF notifies the PCF | Added | | |
| QoS Flow can | when receiving notifications | | | |
| no longer (or | from RAN that GFBR of the | | | |
| can again) be | QoS Flow can no longer (or can | | | |
| guaranteed | again) be guaranteed. | | | |

.
.
.

In a case where the PCF 520 determines that modification in policy counter status reporting is required, spending limit report retrieval may be modified, but is not limited thereto. Thereafter, the PCF 520 may perform a policy decision on the basis of SM policy association updates. Specifically, the PCF 520 may determine updated policy information, which is required to be transmitted to the SMF 510.

As an example, in a case where the SMF 510 reports cumulative usage on a PDU session, the PCF 520 may invoke “Nudr_DM_Update” to the UDR 530 to subtract a corresponding value from the remaining allowed usage for the subscriber, DNN, and S-NSSAI. Other than that, the PCF 520 may perform an operation based on SM policy association modification from the SMF 510 and perform policy decision updates on the basis thereof. Thereafter, the PCF 520 may transmit an SM policy association modification response message to the SMF 510, and the SMF 510 may obtain updated policy information through this operation.

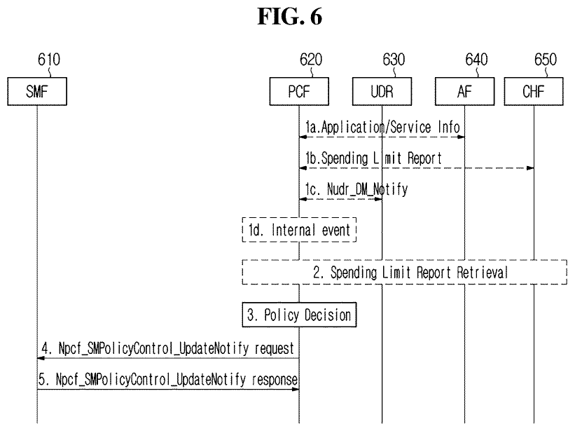

FIG. 6 is a view illustrating a method of performing SM policy association modification initiated by a PCF and applicable to the present disclosure. As an example, the PCF 620 may perform an SM policy association modification procedure on the basis of triggering by another entity (e.g., an AF, network data analytics function (NWDAF), CHF, and UDR) associated with the PCF 620 or an event within the PCF. As a specific example, when obtaining information related to a changed application and service from the AF 640, the PCF 620 may update the policy decision and transmit an SM policy association modification notification request message to the SMF 610. As another example, the PCF 620 may obtain a spending limit report from a CHF 650, update the policy decision on the basis the obtained spending limit report, and transmit the SM policy association modification notification request message to the SMF 610. As a yet another example, the PCF 620 may receive a notification from the UDR 630 on the basis of a subscription. Here, the notification may be “Nudr_DM_Notify”, and the “Nudr_DM_Notify” may include at least one of a notification correlation ID, policy data, an SUPI, updated data, PDU session policy control data, and/or the remaining allowed usage data. The UDR 630 may provide information on a policy subscription change to the PCF 620 on the basis of the above description. Thereafter, the PCF 620 may update the policy decision and transmit the SM policy association modification notification request message to the SMF 610.

As a still another example, the PCF 620 may update the policy decision on the basis of an internal event and transmit the SM policy association modification notification request message to the SMF 610. Here, the internal event may be timer expiration or a local decision based on analysis information requested and received from an NWDAF, but may not be limited thereto.

In a case where a change to the policy counter status reporting is determined to be required on the basis of the descriptions described above, the PCF 620 may change a policy counter subscription list by using an initial, intermediate, or final spending limit report retrieval procedure. When the PCF 620 transmits the SM policy association modification notification request message along with the updated policy information for the PDU session to the SMF 610, the SMF 610 may check the updated policy information, and as a response to the SM policy information, may transmit an SM policy association modification notification response message to the PCF 620.

In the following, a method of indicating a traffic path on the basis of a routing ID (RID) returned for each SDF is described. The RID may be an ID indicating the traffic path (t-path). Here, the RID may be different from a segment ID (SID) of segment routing IPv6 (SRv6). As an example, the SID may be a 128-bit IPv6 address, and a segment list may set an SRv6 path by combining a plurality of segments on the basis of the SID. Specific details about SRv6 will be described later. The SID may consist of fields of Locator, Function, and Argument. As an example, the Locator may be a part for identifying a location of a node and providing IPv6 routing functions, and the Function may refer to a function executed in each node on the basis of a corresponding packet. As an example, routing (or forwarding) of the corresponding packet may be indicated at a specific node on the basis of the Function. The Argument is an auxiliary field for the Function and may include parameter information for a function. As an example, a tunnel endpoint identifier (TEID) may be included in the Argument.

As an example, unlike a SID, an RID may be an ID that consists only of Locator information (prefix) and indicate a traffic path. That is, the RID does not include a TEID and may also not require a configuration with the Function performing a function. Specifically, the RID is an indicator for only indicating a routing path, and may only indicate the traffic path. The RID may be an indicator for indicating only the traffic path, rather than be a component for indicating an operation or service performed at each service node while actual data is forwarded through service nodes. Accordingly, the RID may have a structure different from that of the SID. As a specific example, the RID may be configured in a form of “RID1: G1(Prefix)-U1(Prefix)-S1(Prefix)-U2(Prefix)”, but may not be limited thereto.

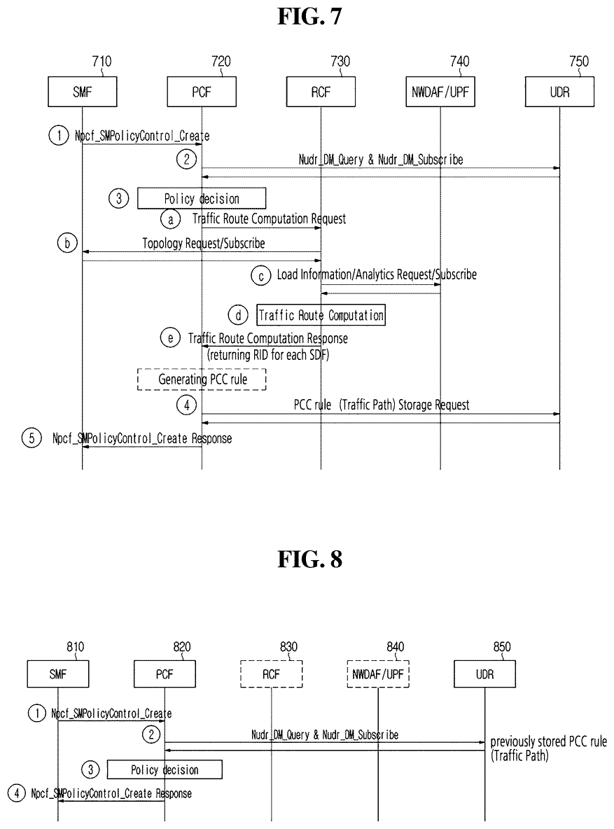

FIG. 7 is a view illustrating a method of performing SM policy association establishment applicable to the present disclosure.

Referring to FIG. 7, an SMF 710 may transmit an SM policy association establishment request message to a PCF 720. The SMF 710 may receive a protocol data unit (PDU) session establishment request message from a UE and select the PCF 720. The SMF 710 may transmit the SM policy association establishment request message to the selected PCF 720. As an example, the above-described request message may include PDU session-related information. As a specific example, the PDU session-related information may further include at least any one of a subscription permanent identifier (SUPI), a PDU session ID, a PDU session type, a data network name (DNN), single-network slice selection assistance information (S-NSSAI), a generic public subscription identifier (GPSI), an internal group identifier, an access type, an IPv4 address, and/or an IPv6 network prefix. In addition, the PDU session-related information may further include additional information other than the information described above, and may not be limited to specific information thereof.

Thereafter, the PCF 720 may inquire about policy-related information from a UDR 750. As a specific example, in a case of not having the policy-related information, the PCF 720 may invoke “Nudr_DM_Query” in order to receive information related to a PDU session. The “Nudr_DM_Query” may include SUPI, DNN, S-NSSAI, policy data, PDU session policy control data, and the remaining allowed usage data, but is not limited thereto. In addition, the PCF 720 may invoke “Nudr_DM_Susbcribe” to the UDR 750 in order to transmit a request for notification when the policy-related information changes. The “Nudr_DM_Susbcribe” may include the policy data, SUPI, DNN, S-NSSAI, notification target address (+notification correlation Id), event reporting information (continuous reporting), PDU session policy control data, and the remaining allowed usage data, but is not limited thereto.

Thereafter, the PCF 720 may perform a policy decision and generate a PCC rule on the basis thereof. Specifically, for the policy decision, the PCF 720 may obtain input information from at least one of an SMF, an AMF, a CHF, an NWDAF, or the UDR. In this case, the PCF 720 may transmit a traffic route computation request message to a routing control function (RCF) 730 on the basis of an SDF. Here, the RCF 730 may be an NF for generating an optimal data path (or a traffic path), but may not be limited to the corresponding name. As an example, an NF for performing the same function as that of the RCF 730 may be defined with a different name. In addition, a RCF function may be an individual NF, but is not limited thereto. As an example, the RCF may be in a form combined with another NF (e.g., the SMF), or may be an NF included in another NE. In the following, for convenience of description, the RCF is described on the basis of an individual NF, but is not limited thereto.

When a traffic route computation request message is received, the RCF 730 may obtain topology information by transmitting a topology request message to the SMF 710. When the topology information is changed through a subscription, the RCF 730 may obtain the changed topology information from the SMF 710. As an example, the SMF 710 may be an NF for managing sessions for services in a network, and may allow UE to receive services therethrough. An operation, administration, and maintenance (OAM) may be an NF for performing operations, management, and maintenance on the network, and may support to monitor the network and help identify and resolve a problem. From the OAM, the SMF 710 may obtain topology-related information on the basis of the path through which traffic is transmitted and transmit the corresponding information to the RCF 730. In addition, the RCF 730 may also directly obtain the topology information by transmitting the topology request message to the OAM.

In addition, the RCF 730 may obtain load information by transmitting a load information/analytics request message to a NWDAF/UPF 740. In addition, when the load information is changed through a subscription, the RCF 730 may obtain the changed load information/analytics from the NWDAF/UPF 740. More specifically, the RCF 730 may obtain the load information and load analysis/prediction information from the NWDAF through the request and the subscription. Since the NWDAF performs a function of collecting and analyzing load information, the RCF 730 may obtain not only the load information but also the load analysis/prediction information from the NWDAF. In contrast, the RCF 730 may only obtain the load information from the UPF. Since the UPF transmits only its own information obtained by measurement, the RCF 730 may obtain only the load information from the UPF.

The NWDAF may be an NF for improving service quality by collecting and analyzing data and optimizing network resources on the basis of the data. The NWDAF may transmit a result of the analyzed data to other NFs. In addition, the UPF may be an NF for transmitting user data in a network. The UPF may perform transmitting and processing of data packets, and may maintain data transmission performance and secure stability through quality of service (QoS) management. Based on the above-described operation, the RCF 730 may obtain the load information and load analysis/prediction information from the NWDAF. In addition, the RCF 730 may obtain the load information from the UPF.

Thereafter, the RCF 730 may calculate a traffic path and return a traffic route computation response message including the calculated traffic path information to the PCF 720. Here, the traffic route computation response message generated on the basis of the traffic route computation may include an RID returned for each SDF. As an example, one or more SDFs may exist within each PDU session, and each SDF may be a flow or a set of flows of UE traffic based on a specific service. Accordingly, each SDF may have a different QoS, and a PCC rule may also be generated for each SDF. As an example, Table 3 shows cases where an RID is returned for each SDF, but this is only an example and may not be limited thereto. Referring to Table 3, traffic route computation may return an RID according to an application ID for each SDF or may return an RID according to a destination descriptor ID, but may not be limited thereto.

TABLE 3

APP1: RID1, G1 - U1 - S1 - U2
DD1: RID2, G1 - U1 - U2
DD2: RID3, G1 - U1- S1 - S2 - U2
APP2: RID4, G1 - U1 - S2 - U2

Thereafter, the PCF 720 may generate a PCC rule by reflecting the traffic path information based on the obtained RID for each SDF. Here, the PCC rule may include policy and control-related information as shown in Table 4 below. As an example, the PCC rule may include: a service data flow detection field for identifying a SDF on the basis of a filter or application identifier for the SDF; and a policy control field including information about a policy applied for each SDF. In addition, as an example, the PCC rule may include SDF template precedence. The SDF template precedence may determine the order in which SDF templates are applied to the UPF on the basis of a traffic pattern list for SDF retrieval. In addition, the PCC rule may include a QoS parameter and a charging parameter within the PCC rule applied to the SDF. In addition, as an example, the PCC rule may include 5G QoS Identifier (5QI), QoS Notification Control (QNC), Maximum Bit Rate (MBR), Guaranteed Bit Rate (GBR), and Allocation and Retention Priority (ARP) within the PCC rule applied to a packet flow by each SDF template. In addition, the PCC rule may further include other fields and is not limited to a specific form thereof. Here, as an example, the PCC rule may include: an RID returned for each SDF as shown in Table 3 described above as each traffic path (t-path); and path information based on the RID. That is, after receiving the RID returned for each SDF, the PCF 720 may reflect the corresponding RID and the path information to the PCC rule as a traffic path in a process of generating the PCC rule.

In addition, as an example, the PCF 720 may transmit policy control request triggers (PCRT) to the SME 710. Thereafter, as described above, the SMF 710 may transmit a policy control decision request message to the PCF 720 when a PCRT condition is satisfied.

TABLE 4

| | | | PCF | |
|---|---|---|---|---|
| | | | permitted to | Differences |
| | | | modify for | compared |
| | | | a dynamic | with table |
| Information | | | PCC rule | 6.3. in TS |
| name | Description | Category | in the SMF | 23.203 [4] |
| Rule identifier | Uniquely identifies the PCC rule, within | Mandatory | No | None |
| | a PDU Session. | | | |
| | It is used between PCF and SMF for | | | |
| | referencing PCC rule. | | | |
| Service data | This part defines the method for | | | |
| flow detection | detecting packets belonging to a service | | | |
| | data flow. | | | |
| Precedence | Determines the order, in which the | Conditional | Yes | None |
| | service data flow templates are applied at | (NOTE 2) | | |
| | service data flow detection, enforcement | | | |
| | and charging. (NOTE 1). | | | |
| Service data | For IP PDU traffic: Either a list of | Mandatory | Conditional | Modified |
| flow template | service data flow filters or an application | (NOTE 3) | (NOTE 4) | (packet |
| | identifier that references the | | | filters for |
| | corresponding application detection filter | | | Ethernet |
| | for the detection of the service data flow. | | | PDU traffic |
| | For Ethernet PDU traffic: Combination | | | added) |
| | of traffic patterns of the Ethernet PDU | | | |
| | traffic. It is defined in clause 5.7.6.3 of | | | |
| | TS 23.501 [2]. | | | |
| Mute for | Defines whether application's start or | Conditional | No | None |
| notification | stop notification is to be muted. | (NOTE 5) | | |
| Charging | This part defines identities and | — | — | — |
| | instructions for charging and accounting | | | |
| | that is required for an access point where | | | |
| | flow-based charging is configured | | | |

.
.
.

| | | | | |
|---|---|---|---|---|
| Policy control | This part defines how to apply policy | | | |
| | control for the service data flow. | | | |
| Gate status | The gate status indicates whether the | | Yes | None |
| | service data flow, detected by the service | | | |
| | data flow template, may pass (Gate is | | | |
| | open) or shall be discarded (Gate is | | | |
| | closed). | | | |
| 5G QoS | The 5QI authorized for the service data | Conditional | Yes | Modified |
| Identifier | flow. | (NOTE 10) | | (corresponds |
| (5QI) | | | | to QCI in |
| | | | | TS 23.203 |
| | | | | [4]) |
| QoS | Indicates whether notifications are | Conditional | Yes | Added |
| Notification | requested from 3GPP RAN when the | (NOTE 15 | | |
| Control | GFBR can no longer (or can again) be | | | |
| (QNC) | guaranteed for a QoS Flow during the | | | |
| | lifetime of the QoS Flow. | | | |
| Reflective | Indicates to apply reflective QoS for the | | Yes | Added |
| QoS Control | SDF. | | | |
| UL- | The uplink maximum bitrate authorized | | Yes | None |
| maximum | for the service data flow | | | |
| bitrate | | | | |
| DL- | The downlink maximum bitrate | | Yes | None |
| maximum | authorized for the service data flow | | | |
| bitrate | | | | |
| UL- | The uplink guaranteed bitrate authorized | | Yes | None |
| guaranteed | for the service data flow | | | |
| bitrate | | | | |
| DL- | The downlink guaranteed bitrate | | Yes | None |
| guaranteed | authorized for the service data flow | | | |
| bitrate | | | | |

.
.
.

| | | | |
|---|---|---|---|
| Traffic Path | The traffic path for the service data flow | Yes | None |

Thereafter, the PCF 720 may request the UDR 750 to store the PCC rule including the traffic path (t-path). The UDR 750 may store the PCC rule and then transmit a response message in response to the PCF 720. After receiving the response message from the UDR 750, the PCF 720 may transmit an SM policy association establishment response message with respect to the SM policy association establishment request message to the SMF 710. Here, the SM policy association establishment response message may include policy information.

FIG. 8 is a view illustrating a method of performing SM policy association establishment applicable to the present disclosure.

Referring to FIG. 8, an SMF 810 may transmit an SM policy association establishment request message to a PCF 820. The SMF 810 may receive a protocol data unit (PDU) session establishment request message from a UE and select the PCF 820. The SMF 810 may transmit the SM policy association establishment request message to the selected PCF 820. As an example, the above-described request message may include PDU session-related information, and this may be the same as shown in FIG. 7 described above. Thereafter, the PCF 820 may inquire about policy-related information from a UDR 850. Here, the UDR 850 may store the PCC rule generated on the basis of FIG. 7. As an example, the PCC rule may include traffic path (t-path) information based on the RID returned for each SDF. As an example, as described above, the RID may consist of only locator information without a TEID.

In a case of not having the policy-related information, the PCF 820 may invoke “Nudr_DM_Query” in order to receive information related to a PDU session, and this may be the same as that shown in FIG. 7. In addition, the PCF 820 may invoke “Nudr_DM_Susbcribe” in order to request to be notified when the policy-related information changes, and this may be the same as that shown in FIG. 7. Here, since the UDR 850 stores the PCC rule, the corresponding information may be transmitted to the PCF 820. The PCF 820 may perform a policy decision on the basis of the PCC rule received from the UDR 850. Thereafter, the PCF 820 may transmit an SM policy association establishment response message with respect to the SM policy association establishment request message to the SMF 810. Here, the SM policy association establishment response message may include policy information.

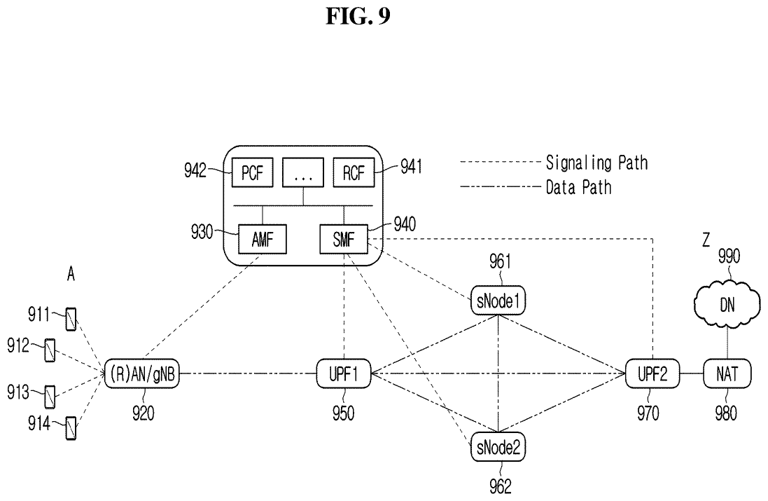

FIG. 9 is a view illustrating a method of performing traffic routing applicable to the present disclosure. As an example, a network of an existing mobile communication system may generate a protocol data unit (PDU) session based on the GPRS tunneling protocol (GTP) and then transmit user data to a data network. Here, regardless of destination IP address values of IP packets, the IP packets transmitted by UEs 911, 912, 913, and 914 (A in FIG. 9) may be transmitted through a GTP-based PDU session on the basis of a GTP tunnel formed by a base station 920 and at least one of UPFs 950 and 970. As an example, referring to FIG. 9, the GTP-based PDU session transmits the packets to a network address translation (NAT) 980 through the fixed GTP tunnel formed along at least one of UPFs, i.e., UPF1 950 and UPF2 970. After receiving the packets, the NAT 980 may transmit the packets to a data network (DN) 990 (Z in FIG. 9) with converted destination IP address values of the IP packets originally transmitted by the UEs. Here, the GTP-based PDU session may be provided through a fixed path from the base station 920 to the UPF2 970. As an example, in a case where packet transmission is performed on the basis of a GTP-based PDU session, tunnel establishment per session may be required in all nodes, whereby there may occur a problem of increasing complexity for a user plane. As another example, since the tunnel establishment per session is required in all the nodes within the fixed path, a plurality of tunnels may be required. Additionally, other protocol-based operations also operate on the basis of the above-described fixed path, so there may occur a problem of increasing complexity. Here, at least one or more UEs 911, 912, 913, and 914 may be connected to the base station 920. Access and mobility of the at least one or more UEs 911, 912, 913, and 914 may be controlled by the AMF 930. In addition, the GTP-based PDU session generated on the basis of the tunneling between the base station 920 and the UPF 970 may be controlled by a SMF 940. The SMF 940 may select the UPFs 950 and 970 to be used by at least one or more UEs 911, 912, 913, and 914.

As a specific example, the UEs may perform radio resource control (RRC) connection for network connection. Thereafter, the UEs may transmit a PDU session establishment request message to the AMF 930 for PDU session establishment. The PDU session establishment request message may include various kind of setting information for the PDU session establishment. As an example, the PDU session establishment request message may include a PDU session type, QoS information, and other information, and is not limited to a specific form thereof. After receiving the PDU session establishment request message, the AMF 930 may perform authentication and registration for the UEs and select the SMF 940. The AMF 930 may select the SMF 940 on the basis of a type of service used by the UEs, QoS requirements, and other factors. After the SMF 940 is selected, the AMF 930 may transmit the request message for session management (SM) context creation to the SMF 940 and receive a response message in response, so as to complete the PDU session establishment. As an example, the SM context may include information for the PDU session, and may include a PDU session identifier, security and encryption settings for the PDU session, QoS information, and other information. The SMF 940 may obtain information on a subscription from UDM, create an SM context, and provide the response message to the AMF 930. Thereafter, the SMF 940 may perform PCF selection, and establish or modify an SM policy association on the basis of a policy of the selected PCF. Thereafter, the SMF 940 may select the UPFs 950 and 970 and establish a session (i.e., an N4 session) with the UPFs 950 and 970. Thereafter, the SMF 940 may perform message exchange with the AMF 930. The AMF 930 may transmit a request message for establishing a session (i.e., an N2 session) with the base station 920. The base station 920 may transmit an establishment request message to the UEs and then transmit a session establishment response message to the AMF 930. The session establishment response message may include (R)AN GTP-U tunnel endpoint information, etc. Based on the above description, a PDU session for uplink may be established. When uplink data is generated, each UE transmits data to the base station 920, and the base station 920 may transmit the packets to the UPF 970 on the basis of the GTP-based PDU session. Thereafter, the AMF 930 may transmit an SM context update request message to the SMF 940 and receive a response message in response. The SMF 940 may transmit (R)AN GTP-U tunnel endpoint information for downlink transmission and other information to the UPFs 950 and 970 along with an N4 session modification request message. Thereafter, the SMF 940 may receive an N4 session modification response message, and when downlink data is generated, the packets may be transmitted to the UEs through the UPFs 950 and 970. However, the GTP-based PDU session may be a static fixed path based on the selected path as described above.

As an example, in FIG. 9, segment routing IPv6 (SRv6) may be applied between the access network and the UPFs. Here, the SRv6 may support both of the access network and the core network. As another example, the SRv6 may be applied only to the core network and not to the access network, but this is not limited to a specific exemplary embodiment thereof. In a case where a session is established on the basis of the SRv6 instead of a GTP-based tunnel, dynamic path establishment may be possible for each SDF. As an example, based on the SRv6, a traffic path may be determined for each SDF related to a PDU session, and thus data transmission may be performed.

Here, due to supporting of source routing technology, SRv6 may provide application services with paths configured with the UPFs 950 and 970 or nodes 961 and 962, which are suitable for the characteristics of user data within the core network. As an example, the nodes may be other UPFs, servers, and other types of devices, and are not limited to a specific type thereof. As a specific example, a source node (e.g., a node 920 or 970) may select a path and encode path information in a packet header. Here, a segment routing header may include an IPv6 segment list based on IPv6, and a packet may be transmitted from the source node to an IPv6 destination node along the nodes corresponding to each segment list on the basis of path information. As an example, an SRv6 segment may be identified through a segment identifier (SID) encoded in IPv6.

After generating a PDU session based on SRv6, user data may be transmitted to a data network, and a traffic path may be dynamically established for each SDF within the SRv6-based PDU session. The SRv6-based PDU session may relate to a case where the session is established on the basis of the SRv6. The SRv6-based PDU session may establish dynamic paths different from those in a GTP-based PDU session. As an example, for specific packets, an SRv6-based PDU session may be built for paths between the base station 920 and the UPF1 950, between the UPF1 950 and the sNode1 961, and between the sNode1 961 and the UPF2 970. In this way, the specific packets may be transmitted to the DN 990 through the above-described paths. In contrast, for other specific packets, an SRv6-based PDU session may be built for paths between the base station 920 and the UPF1 950, between the UPF1 950 and the sNode2 962, and between the sNode2 962 and the UPF2 970. In this way, other specific packets may be transmitted to the DN 990 through the above-described paths. That is, each packet may be transmitted to the DN 990 through the paths different from each other. Here, as an example, a path for each packet may be determined differently on the basis of a packet type or a service. In addition, each node may be a server or a UPF, and a different operation may be performed for each node. As an example, a specific node may be a node serving as a security server for performing verification of packets, and another specific node may be a server with account of encoding or decoding operations, and is not limited to a specific form thereof. That is, the packets may be transmitted through the paths including the corresponding nodes depending on the packet type or service. Here, SRv6 may support the dynamic paths as described above through IPv6-based path establishment. However, a GTP tunnel transmits packets through a fixed PDU session, so dynamic path establishment as described above may not be achievable.

Here, when routing is performed on the basis of the dynamic path establishment in FIG. 9, a traffic path is indicated through a SID based on the above-described SRv6, and each operation in a node may be indicated. In contrast, in a case where a traffic path is indicated through a policy decision in the PCF on the basis of the above-described PCC rule, an RID including only Locator may be used without using an SID. That is, in a case where the traffic path is indicated on the basis of the policy decision, the Function or the Argument of the SID may not be required, so the traffic path may be indicated with the RID including only the Locator. As an example, as described above, a traffic path may be indicated on the basis of a RID returned for each SDF included in a PCC rule.

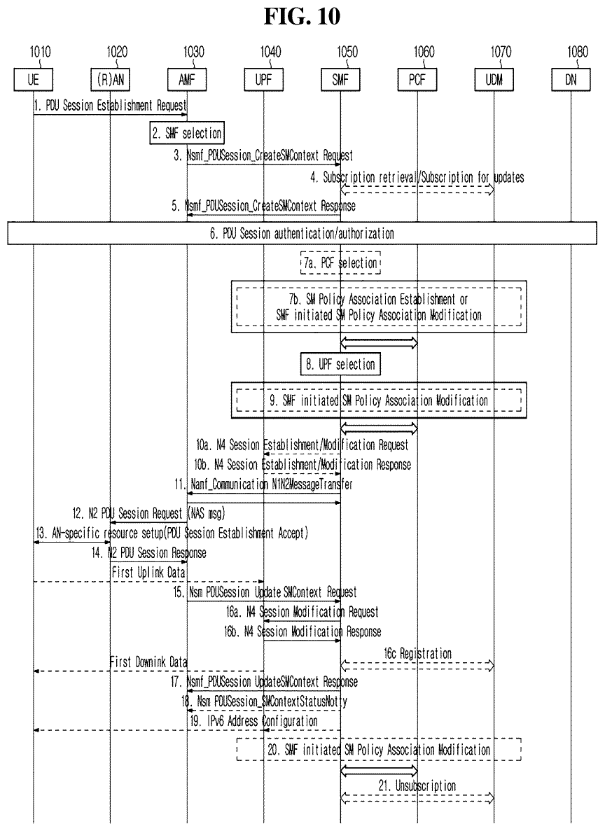

As an example, FIG. 10 is a view illustrating a method for establishing a path in a PDU session procedure applicable to the present disclosure. Referring to FIG. 10, a UE 1010 may perform RRC connection for network connection. Thereafter, the UE 1010 may transmit a PDU session establishment request message to an AMF 1030 to establish a PDU session. As an example, the PDU session establishment request message may be a NAS message and include various kind of setting information for the PDU session establishment. As an example, the PDU session establishment request message may include single-network slice selection assistance information (S-NSSAI), a data network name (DNN) requested by UE, a PDU session ID, a PDU session type, an existing PDU session ID, an N1 SM container, quality of service (QoS) information, and other information. As an example, the S-NSSAI may include: a slice/service type (SST) for indicating a network slice characteristic type; and a slice identifier (i.e., a slice differentiator: SD) as optional information for complementing the slice/service type in order to distinguish a plurality of network slices, but this may not be limited thereto. In addition, the DNN requested by UE may identify a data network related to a service used by the UE with a data network name requested by the UE. In addition, the PDU session ID may be an ID of a PDU session to be newly set, and the existing PDU session ID may be an ID of a previous PDU session. In addition, as an example, the N1 SM container may include a PDU session establishment request, a port management information container, etc.

Thereafter, after receiving the PDU session establishment request message, the AMF 1030 may perform authentication and registration for the UE 1010 and select an SMF 1050. The AMF 1030 may select the SMF 1050 on the basis of factors including a service type used by the UE 1010, QoS requirements, and others. After the SMF 1050 is selected, the AMF 1030 transmits an SM context request (i.e., Nsmf_PDUsession_CreateSMContext Request) message for creating an SM context to the SMF 1050, and the SMF 1050 performs, with a UDM 1070, a procedure of subscription retrieval/subscription for updates, obtains subscription information from the UDM 1070, and creates the SM context. Thereafter, the SMF 1050 may complete establishing the PDU session by transmitting an SM context response (i.e., Nsmf_PDUsession_CreateSMContext Response) message to the AMF 1030. As an example, the SM context may include information for the PDU session, and may include a PDU session identifier, security and encryption settings for the PDU session, QoS information, and other information. As a yet another example, the SM context may further include information related to path selection, but may not be limited thereto.

When the establishing of the PDU session is completed, a PDU session authentication/authorization process is performed.

The SMF 1050 may perform selecting of a PCF 1060, and may set or change an SM policy association (or a session management policy) on the basis of a policy of the selected PCF 1060. As an example, the SMF 1050 may select the PCF 1060 and then transmit an SM policy association establishment request message to the selected PCF 1060. Here, the PCF 1060 may perform a policy decision on the basis of the SM policy association establishment request from the SMF 1050, include the determined policy information in an SM policy association establishment response message, and transmit the SM policy association establishment response message to the SMF 1050.

In a case where a PCC rule corresponding to a SDF is already stored in the UDR, the PCF 1060 may obtain PCC rule information from the UDR to determine a policy, and return the corresponding information to the SMF 1050, and this may be the same as that shown in FIG. 8 described above. In contrast, in a case where the PCC rule corresponding to the SDF is not stored in a UDR, the PCF 1060 may perform a policy decision and PCC rule creation, and return the corresponding information to the SMF 1050, and this may be the same as that shown in FIG. 7.

As an example, PCC rule may include traffic path information. More specifically, as described above, the PCC rule may include RID information returned for each SDF and information on each traffic path. As another example, after selecting the PCF 1060, the SMF 1050 may transmit an SM policy association modification request message to the selected PCF 1060 and receive an SM policy association modification response message. Here, in a case where an update to the policy decision is performed, the updated policy information may be transmitted to the SMF 1050. As an example, as described above, the updated policy information may also include the RID information returned for each SDF and the information on each traffic path.

Thereafter, the SMF 1050 may select a UPF 1040 and establish a session (i.e., an N4 session) with the UPF 1040. Here, as an example, the SMF 1050 may select the UPF 1040, transmit an SM policy association modification request message to the PCF 1060, and then receive an SM policy association modification response message. Here, in a case where an update to the policy decision is performed, the updated policy information may be transmitted to the SMF 1050. As an example, as described above, the updated policy information may also include the RID information returned for each SDF and the information on each traffic path. That is, a PCC rule may include an RID returned for each SDF, and a traffic path (t-path) may be indicated therethrough.

Here, as an example, in a case where the SMF 1050 starts establishing a PDU session, the SMF 1050 may assign an uplink TEID and a downlink TEID on the basis of the RID as the above-described traffic path information. That is, the traffic path information may be indicated on the basis of the above-described RID. However, for routing to transmit and receive actual data, a SID-based SR path may be established. As an example, since a TEID may be a tunnel which is set to be one-way, it is required to assign the uplink TEID and the downlink TEID separately. Thereafter, the SMF 1050 may determine an SR path for uplink. As an example, the SR path for the uplink and an SR path for the downlink may also be the same, but may not be limited thereto. Regarding the SR path for the uplink, the SR path for the uplink may be configured with a segment list, and the segment list may include a SID. In SRv6, a path may be configured through segment routing on the basis of the SID.

Thereafter, the SMF 1050 may perform a message exchange (i.e., Nsmf_Communication N1N2MessageTransfer) with the AMF 930, and the AMF 1030 may transmit a request message for establishing a session (N2 session) to a base station 1020, that is, an N2 PDU session request message or a session establishment request message. In this case, the N2 PDU session request message may be transmitted through a NAS message. Here, as an example, the session establishment request message transmitted from the AMF 1030 to the base station 1020 may include, as PDU session information, UPF tunneling information (e.g., a UPF TEID) and QoS information, but is not limited thereto. As another example, the session establishment request message may include the above-described SR path information. Thereafter, in order to set up (R)AN-related resources, the base station 1020 performs message exchange for AN-specific resource setup (i.e., PDU Session Establishment Accept) with the UE 1010, and then transmit a session establishment response message to the AMF 1030. Here, the PDU session establishment response message transmitted to the AMF 1030 may include (R)AN tunneling information (e.g., an (R)AN TEID) and other information, and thus a PDU session may be established on the basis of the above description. As described above, when uplink data is generated, the UE 1010 may transmit the data to the base station 1020, and the base station 1020 may transmit packets on the basis of the above-described path information.

Thereafter, the AMF 1030 may transmit, to the SMF 1050, a PDU session update SM context request (i.e., Nsmf_PDUsession_UpdateSMContext request) message. The SMF 1050 may recognize the (R)AN TEID information and other information on the basis of the PDU session update SM context request. Here, the SMF 1050 may generate a downlink traffic path on the basis of the SR path information, (R)AN TEID information, and other information, and transmit, to the UPF 1040, the generated downlink traffic path along with an N4 session modification request message. Thereafter, the SMF 1050 may receive an N4 session modification response message. As described above, when downlink data is generated, packets may be transmitted to the UE 1010 through the UPF 1040.

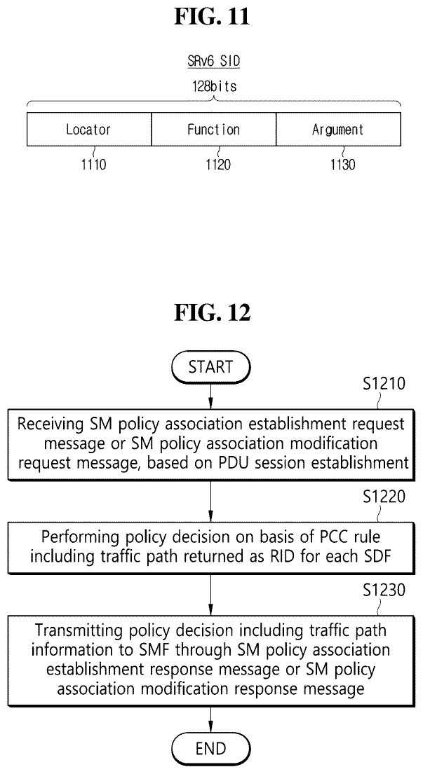

As an example, FIG. 11 is a view illustrating an SID structure applicable to the present disclosure. In consideration of dynamic path establishment, the above-described SRv6 may be applied between access networks and UPFs. A GTP-based tunnel may be static path establishment, but when a session is established on the basis of SRv6, dynamic path establishment is enabled. As an example, a PDU session may be generated on the basis of the SRv6, whereby transmission is performable. Because of supporting source routing technology, the SRv6 may provide application services with paths consisting of UPFs or nodes appropriate for the characteristics of user data within a core network. As a specific example, a source node may select a path and encode path information in a packet header. Here, a segment routing header may include an IPv6 segment list based on IPv6, and a packet may be transmitted from the source node to an IPv6 destination node along nodes corresponding to each segment list on the basis of the path information. As an example, an SRv6 segment may be identified through a segment identifier (SID) encoded on the basis of IPv6, and the SID may be as shown in FIG. 11. Specifically, the SRv6 SID for identifying the SRv6 segment may be a 128-bit IPv6 address as shown in FIG. 11, and may consist of Locator 1110, Function 1120, and Argument 1130. As an example, topology and service requirements may be reflected in each segment. A topology segment may be set to transmit a packet to a specific node or an interface of the node, and a service-related segment may process the packet or quality of service (QoS) on the basis of a specific container. In consideration of the above-described points, the SID may be configured by including the Locator 1110, Function 1120, and Argument 1130. The Locator 1110 may include routing prefix information for routing. Based on the Locator 1110, a packet may be transmitted to a node that should perform the Function for specifying processing on the corresponding packet. That is, the Locator 1110 may be a part that identifies a location of a node and provides IPv6 routing functions. As an example, in a case of an existing IPv6 address, all the 128-bits are used as Locator, but in SRv6, only a portion of a size is used as the Locator on the basis of a network structure, and the remaining portion may be configured as a part for performing a function. In addition, as an example, the Function 1120 may refer to a function executed in each node on the basis of a corresponding packet. That is, the Function 1120 may mean a function to be performed for packet processing in a node identified through the Locator. As an example, the node may perform the function indicated in the Function 1120 on the basis of network service implementation. As an example, routing (or forwarding) of the corresponding packet may be indicated at a specific node on the basis of the Function 1120. As another example, a decoding function for the corresponding packet may be performed at the specific node on the basis of the Function 1120, and is not limited to an corresponding exemplary embodiment. That is, the Function 1120 may refer to the function executed in the node on the basis of the corresponding packet. Here, the Argument 1130 is an auxiliary field for the Function 1120 and may include parameter information for a function. That is, the Argument 1130 may indicate additional information and factors, which are related to the Function 1120. The Argument 1130 may be an optional component, but is not limited thereto. As an example, the above-described TEID may be included in the Argument 1130. As an example, as described above, the above-described RID may include only the Locator 1110 from among an SID. A 128-bit SID includes a plurality of parts, and a function on a routing path and at each node may be performed on the basis of the SID. As an example, the Locator 1110 may be composed of 72 bits, the Function 1120 may be composed of 16 bits, and the Argument 1130 may be composed of 40 bits, but these may not be limited thereto. As an example, in a case where an SMF performs a session establishment procedure on the basis of a UE request, the SMF may assign an uplink tunnel endpoint ID (TEID) and a downlink TEID on the basis of session establishment. In addition, the SMF may calculate SR paths (including for the uplink and the downlink) on the basis of SRv6, and may compose a SID list. The SMF may perform an N4 session establishment procedure with each node in the SR paths on the basis of the calculated SR paths. Here, the SMF may transmit a packet detection rule (PDR) and an enhanced forwarding action rule (eFAR) to a node along with an N4 session establishment request message. In this way, the SMF may set the PDR and eFAR on each node. That is, the PDR may be set as a rule for recognizing a packet at each node, and the eFAR may be set as a rule for forwarding the packet. Here, the eFAR may include a forwarding condition field, an action field, and a destination field. As an example, the eFAR may further include a function for SRv6 in the above-described action field.

That is, the SMF may compose an SRv6-based SID list for nodes in the SR paths in relation to packet transmission, and the SID may include the Locator 1110, Function 1120, and Argument 1130 as shown in FIG. 11 in relation to each node. The SMF may identify a path for each node in the SR paths through the SID, recognize the functions performed at each node, and indicate corresponding information by setting PDR and eFAR while performing the N4 session establishment procedure with each node.

Thereafter, the SMF may transmit uplink TEID information to a base station on the basis of the SR paths, and the base station may generate a downlink TEID. As an example, as for TEID, unidirectional TEIDs for uplink and downlink may be required separately. The base station may respond to the SMF by a PDU session response message including the generated downlink TEID information. Thereafter, the SMF may calculate a SR path for downlink on the basis of the TEIDs of each node. The SMF may transmit a PDR and eFAR for the downlink to each node by performing an N4 session modification procedure with each node, and thus settings for downlink transmission may be completed on the basis of the description above.

FIG. 12 is a flowchart for PCF operation to which the present disclosure is applicable. Referring to FIG. 12, in step S1210, a PCF may receive an SM policy association establishment request message or an SM policy association modification request message, based on PDU session establishment. Thereafter, in step S1220, the PCF may perform a policy decision on the basis of a PCC rule including a traffic path returned as an RID for each SDF. Thereafter, in step S1230, the PCF may transmit the policy decision including traffic path information to an SMF through an SM policy association establishment response message or an SM policy association modification response message. As an example, the traffic path included in the PCC rule may include the RID and specific path information which is configured to be returned for each SDF. Here, one or more SDFs may exist within each PDU session, and each SDF may be a flow or a set of flows of UE traffic based on a specific service. Accordingly, each SDF may have a different QoS, and the PCC rule may also be generated for each SDF. In addition, unlike the SID described above, the RID returned for each SDF is composed of only the locator and may indicate the traffic path.

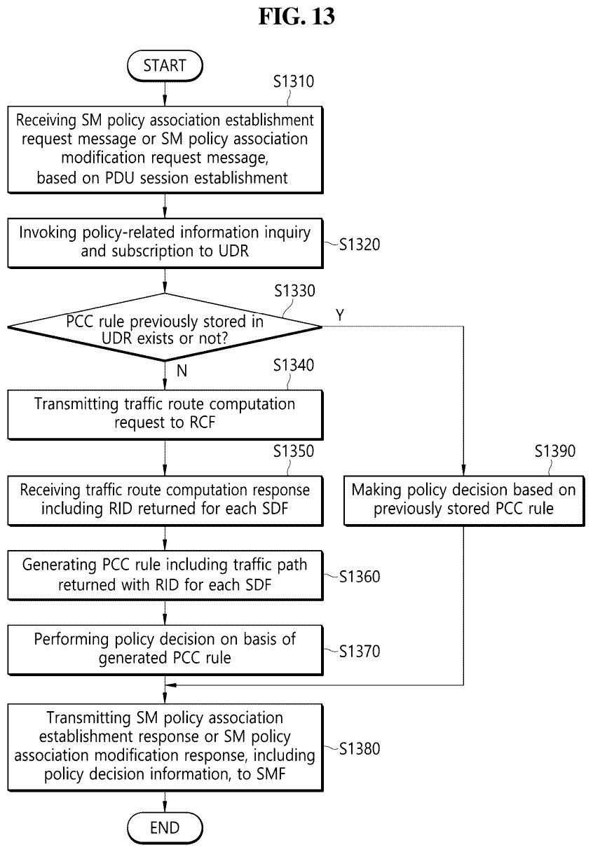

FIG. 13 is a flowchart for PCF operation applicable to the present disclosure. Referring to FIG. 13, in step S1310, a PCF may receive an SM policy association establishment request message or an SM policy association modification request message, based on PDU session establishment. Thereafter, in step S1320, the PCF may invoke policy-related information inquiry and subscription to a UDR. Here, in step S1330, a policy decision may be performed on the basis of whether PCC rule information previously stored in the UDR exists or not. Specifically, in step S1340, in a case where a PCC rule previously stored in the UDR does not exist, the PCF may transmit a traffic route computation request message to an RCF. As an example, the RCF may transmit a topology request message to an SMF and obtain a topology response message including topology information from the SMF. In addition, the RCF may transmit a load request message to an NWDAF/UPF and obtain a load response message including load information from the NWDAF/UPF. Thereafter, the RCF may calculate a traffic path and return an RID for each SDF. That is, in step S1350, the PCF may receive a traffic route computation response message including the RID returned for each SDF. In step S1360, the PCF may generate the PCC rule including the traffic path returned with the RID for each SDF. In addition, the PCF may store the generated PCC rule in the UDR. Thereafter, in step S1370, the PCF may perform a policy decision on the basis of the generated PCC rule. In step S1380, as described above, the PCF may transmit an SM policy association establishment response message or an SM policy association modification response message, which includes policy decision information, to the SMF. In contrast, in step S1390, in a case where the PCC rule previously stored in the UDR exist, the PCF may make the policy decision based on the previously stored PCC rule. Thereafter, in step S1380, as described above, the PCF may transmit the SM policy association establishment response message or SM policy association modification response message, which includes the policy decision information, to the SMF.

Here, as an example, traffic path information within a PCC rule may be returned as an RID for each SDF, but in a case where a PDU session is established on the basis of PDU session establishment, routing of the PDU session may be performed through an SID of SRv6. As an example, the SID may include: a Locator for identifying a location of a node and indicating a routing function; a Function for indicating a function to be executed in each node on the basis of a packet; and an Argument including parameter information and a TEID related to the function. In contrast, as described above, the RID may only include the Locator.

Meanwhile, the exemplary embodiment of the present disclosure is not implemented only through the apparatus and/or method described so far, but may also be implemented through a program that realizes a function corresponding to the configuration of the exemplary embodiments of the present disclosure or a recording medium on which the program is recorded, and such implementation may be easily implemented by those skilled in the art to which the present disclosure pertains from the description of the above-described exemplary embodiments. Specifically, the method (e.g., a network management method, data transmission method, transmission schedule creation method, etc.) according to the exemplary embodiments of the present disclosure is implemented in the form of program instructions that may be executed through various computer means, and may be stored in a computer-readable medium. The computer-readable medium may include program instructions, data files, data structures, and the like alone or in combination. The program instructions recorded on the computer-readable medium may be specially designed and configured for the exemplary embodiments of the present disclosure, or may also be known and usable by those skilled in the art of computer software. The computer-readable recording medium may include a hardware device configured to store and perform the program instructions. For example, the computer-readable recording medium may be one of magnetic media such as hard disks, floppy disks, and magnetic tapes, optical media such as CD-ROMs and DVDs, magneto-optical media such as floptical disks, and media such as ROM, RAM, and flash memory. The program instructions may include not only machine language code such as that generated by a compiler, but also high-level language code that may be executed by a computer through an interpreter, etc.

Although the exemplary embodiments of the present disclosure have been described in detail above, the scope of the present disclosure is not limited thereto, and various modifications and improvements of those skilled in the art using the fundamental concepts of the present disclosure as defined in the following claims are also included in the scope of the present disclosure.

What is claimed is:

1. An apparatus for establishing a traffic path and transmitting the established traffic path in a mobile communication system, the apparatus comprising:
a memory for storing at least one program;
a transmitting and receiving unit for transmitting and receiving at least one signal; and
a processor for executing the at least one program stored in the memory,
wherein the processor receives an SM policy association establishment request message or an SM policy association modification request message on the basis of protocol data unit (PDU) session establishment, obtains policy-related information from a unified data repository (UDR) on the basis of an SM policy association establishment request or an SM policy association modification request, and performs a policy decision on the basis of whether a previously stored policy and charging control (PCC) rule related to the PDU session establishment exists in the policy-related information, and
the policy decision comprises traffic routing for each service data flow (SDF), and transmits an SM policy association establishment response message or an SM policy association modification response message, which comprises policy decision information, to a session management function (SMF).

2. The apparatus of claim 1, wherein in a case where the PCC rule exists in the policy-related information, the processor performs the policy decision on the basis of the PCC rule and transmits the SM policy association establishment response message or the SM policy association modification response message, which comprises the policy decision information, to the SMF.

3. The apparatus of claim 1, wherein, in a case where the PCC rule does not exist in the policy-related information, the processor generates the PCC rule, performs the policy decision on the basis of the generated PCC rule, and transmits the SM policy association establishment response message or the SM policy association modification response message, which comprises the policy decision information, to the SMF.

4. The apparatus of claim 3, wherein, in a case of the generating of the PCC rule, the processor transmits a traffic route computation request message to a routing control function (RCF),
the RCF obtains topology information and load information, and performs traffic route computation for each service data flow (SDF) on the basis of the obtained topology information and load information, and generates a routing identification (RID) for each SDF, and
wherein the processor receives a return of the RID, which is determined for each SDF, through a traffic route computation response message.

5. The apparatus of claim 4, wherein the RID returned for each SDF is comprised in the PCC rule and is transmitted to the SMF.

6. The apparatus of claim 4, wherein, when the PCC rule comprising the RID returned for each SDF is generated, the processor transmits a PCC rule storage request message to the UDR to store the generated PCC rule in the UDR.

7. The apparatus of claim 4, wherein the RCF transmits a topology request message to the SMF and obtains a topology response message comprising the topology information from the SMF.

8. The apparatus of claim 4, wherein the RCF transmits a load request message to a network data analytics function (NWDAF) or a user plane function (UPF) and obtains a load response message comprising the load information from the NWDAF or the UPF.

9. The apparatus of claim 1, wherein the PCC rule comprises traffic path information,
the traffic path information indicates the traffic path through an RID returned for each SDF, and
routing of the PDU session is performed through a segment ID (SID) of segment routing IPv6 (SRv6) in a case where the PDU session is established on the basis of the PDU session establishment.

10. The apparatus of claim 9, wherein the SID comprises:
a locator for identifying a location of a node and indicating a routing function;
a function for indicating a function to be executed in each node on the basis of a packet;
an argument comprising parameter information related to the function and a tunnel endpoint ID (TEID); and
wherein the RID includes only the locator.

11. The apparatus of claim 1, wherein the device for establishing the traffic path and transmitting the established traffic path is a policy control function (PCF).

12. A method of operating an apparatus for establishing a traffic path and transmitting the established traffic path in a mobile communication system, the method comprising:
receiving an SM policy association establishment request message or an SM policy association modification request message on the basis of protocol data unit (PDU) session establishment;
obtaining policy-related information from a unified data repository (UDR) on the basis of an SM policy association establishment request or an SM policy association modification request; and
performing a policy decision on the basis of whether a previously stored policy and charging control (PCC) rule related to the PDU session establishment exists in the policy-related information,
wherein the policy decision comprises traffic routing for each service data flow (SDF) and comprises a step of transmitting an SM policy association establishment response message or an SM policy association modification response message, which comprises policy decision information, to a session management function (SMF).

13. The method of claim 12, further comprising:
performing the policy decision on the basis of the PCC rule in a case where the PCC rule exists in the policy-related information; and
transmitting the SM policy association establishment response message or the SM policy association modification response message, which comprises the policy decision information, to the SMF.

14. The method of claim 12, further comprising:
generating the PCC rule in a case where the PCC rule does not exist in the policy-related information;
performing the policy decision on the basis of the generated PCC rule; and
transmitting the SM policy association establishment response message or the SM policy association modification response message, which comprises the policy decision information, to the SMF.

15. The method of claim 14, further comprising:
transmitting a traffic route computation request message to a routing control function (RCF) in a case of the generating of the PCC rule,
wherein the RCF comprises steps of:
obtaining topology information and load information;
performing traffic route computation for each service data flow (SDF) on the basis of the obtained topology information and load information; and
generating a routing identification (RID) for each SDF for the requester to receive a return of the RID, which is determined for each SDF, through a traffic route computation response message.

16. The method of claim 15, wherein the RID returned for each SDF is comprised in the PCC rule and comprises a step of being transmitted to the SMF.

17. The method of claim 15, further comprising:
transmitting a PCC rule storage request message to the UDR to store the generated PCC rule in the UDR when the PCC rule comprising the RID returned for each SDF is generated.

18. The method of claim 15, wherein the RCF comprises steps of:
transmitting a topology request message to the SMF; and
obtaining a topology response message comprising the topology information from the SMF.

19. The method of claim 15, wherein the RCF comprises steps of:
transmitting a load request message to a network data analytics function (NWDAF) or a user plane function (UPF); and
obtaining a load response message comprising the load information from the NWDAF or the UPF.
